(19) United States
(12) Patent Application Publication
(10) Pub. No.: US 2016/0128069 A1
(43) Pub. Date: May 5, 2016

(54) DE-SENSE CHARACTERIZATION WITH ACCURATE ESTIMATION OF TX BACKOFF BASED ON DYNAMIC CHANNEL CONDITIONS

(71) Applicant: QUALCOMM Incorporated, San Diego, CA (US)

(72) Inventors: Appala Naga Raju Bodduru, Hyderabad (IN); Rahul Gupta, Hyderabad (IN); Cheol Hee Park, San Diego, CA (US)

(21) Appl. No.: 14/527,636

(22) Filed: Oct. 29, 2014

(51) Int. Cl. H04W 72/04; H04B 17/382; H04L 12/26

(52) U.S. Cl. CPC H04W 72/0473; H04L 43/0823; H04B 17/382; H04W 72/085

(57) ABSTRACT

A method for determining transmission power backoff includes: for each combination of a plurality of predetermined receive (RX) signal power levels and transmit (TX) signal power levels: setting the RX signal power level for a first radio access technology (RAT) to one of the predetermined power levels; setting the TX signal power level for a second RAT to one of the predetermined power levels; subtracting a predetermined TX power backoff amount from the predetermined TX signal power level and transmitting the TX signal; measuring the RX signal frame error rate (FER); and increasing the TX power backoff amount by a predetermined amount until the FER is not greater than a predetermined threshold value at the predetermined RX signal power level.

### BACKGROUND

Receiver de-sense is a degradation of receiver sensitivity by multiple possible factors which can be internal, external, in-band, out-of-band, transmitted conducted, radiated, or some combination. It is an unwanted phenomenon that can affect wireless communication devices using digital modulations on multiple networks and bands.

Conventional solutions for receiver de-sense include band/channel avoidance and reducing transmit (TX) power on an aggressor radio access technology (RAT) (i.e., a RAT causing interference) to reduce receive (RX) problems on a victim RAT (i.e., a RAT being interfered with). In conventional power reduction solutions, TX power backoff levels for an aggressor RAT are fixed for a large dynamic range of a victim's Rx power level. The fixed backoff levels may adversely affect data throughput of the aggressor RAT for which TX power is backed off.

Also, antenna and front end circuitry characteristics, which are assumed to be fixed, can vary from device to device causing the actual TX backoff to vary. Blocking or interference can result in a sudden drop in the receiver automatic gain control (RXAGC) value on a victim RAT resulting in TX power backoff on an aggressor RAT without knowledge of the actual interference.

Currently, the power backoff table is a fixed table programmed into a mobile communication device. Because the table is fixed, different mobile communication device characteristics and channel conditions are not accounted for. In some cases, the aggressor RAT (e.g., Long Term Evolution (LTE) or other RAT) TX power may be unnecessarily backed off when the victim RAT (e.g., Global System for Mobile communications (GSM) or other RAT) RX signal power is low but signal-to-noise ratio (SNR) is acceptable. Backing off the TX power can cause problems with throughput for the aggressor RAT and so should not be done unnecessarily.

### SUMMARY

Apparatuses and methods for de-sense characterization estimation of TX backoff are provided.

According to various embodiments there is provided a method for determining transmission power backoff. The method may include: for each combination of a plurality of predetermined receive (RX) signal power levels and transmit (TX) signal power levels: setting an RX signal power level for a first radio access technology (RAT) to one of the predetermined power levels; setting a TX signal power level for a second RAT to one of the predetermined power levels; subtracting a predetermined TX power backoff amount from the predetermined TX signal power level and transmitting the TX signal; measuring a frame error rate (FER) of the RX signal; and increasing the TX power backoff amount by a predetermined amount until the FER is not greater than a predetermined threshold value at the predetermined RX signal power level.

According to various embodiments there is provided a method for determining transmission power backoff offset. The method may include: for a plurality of predetermined receive (RX) signal frequencies: setting a predetermined constant RX signal power level for a first radio access technology (RAT) to one of the predetermined frequencies; setting a predetermined constant transmit (TX) signal power level for a second RAT at a fixed frequency; subtracting a predetermined TX power backoff amount from the predetermined TX signal power level and transmitting the TX signal; measuring a frame error rate (FER) of the RX signal; and increasing the TX power backoff amount by a predetermined amount until the FER is not greater than a predetermined threshold value at the predetermined RX signal frequency.

According to various embodiments there is provided a method for determining transmission power backoff. The method may include: for each combination of a plurality of predetermined receive (RX) signal power levels, transmit (TX) signal power levels, and RX signal-to-noise ratios (SNRs): setting an RX signal power level for a first radio access technology (RAT) to one of the predetermined power levels; setting an RX signal SNR to one of the predetermined SNRs; setting a TX signal power level for a second RAT to one of the predetermined power levels; subtracting a predetermined TX power backoff amount from the predetermined TX signal power level and transmitting the TX signal; measuring a frame error rate (FER) of the RX signal; and increasing the TX power backoff amount by a predetermined amount until the FER is not greater than a predetermined threshold value at the predetermined RX signal power level and SNR.

According to various embodiments there is provided a method for backing off transmission power for a mobile communication device. The method may include: determining that a frequency band overlap exists between a receive (RX) frequency band for a first RAT and a transmit (TX) frequency band for a second RAT; applying a TX power backoff to the second RAT, the TX power backoff corresponding to an RX signal power level for the first RAT and a TX power level for the second RAT; performing frame error rate (FER) measurements and signal-to-noise (SNR) measurements on the RX signal on the first RAT; increasing the TX power backoff to the second RAT by a predetermined amount and applying the increased TX power backoff to the second RAT; and inhibiting second RAT transmissions if increasing the TX power backoff to the second RAT does not cause the FER of the RX signal on the first RAT to become equal to or less than the predetermined threshold.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a diagram illustrating a setup for generating the de-sense characterization backoff table and the RX RAT frequency sweep backoff offset table according to various embodiments;

FIG. 3 is a flowchart illustrating a method for generating a de-sense characterization backoff table according to various embodiments;

FIG. 4 is an example of a de-sense characterization backoff table according to various embodiments;

FIG. 5 is a diagram illustrating a setup for generating de-sense characterization backoff tables corresponding to different SNRs according to various embodiments;

FIG. 6 is a flowchart illustrating a method for generating a plurality of de-sense characterization backoff tables corresponding to different SNRs according to various embodiments;

FIG. 7 is a flowchart illustrating a method for generating an RX RAT frequency sweep backoff offset table according to various embodiments;

FIG. 8 is a flowchart illustrating a method for calculating FER for TX power backoff in runtime according to various embodiments; and

FIG. 9 is a flowchart illustrating a method for generating an SNR TX power backoff offset table according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

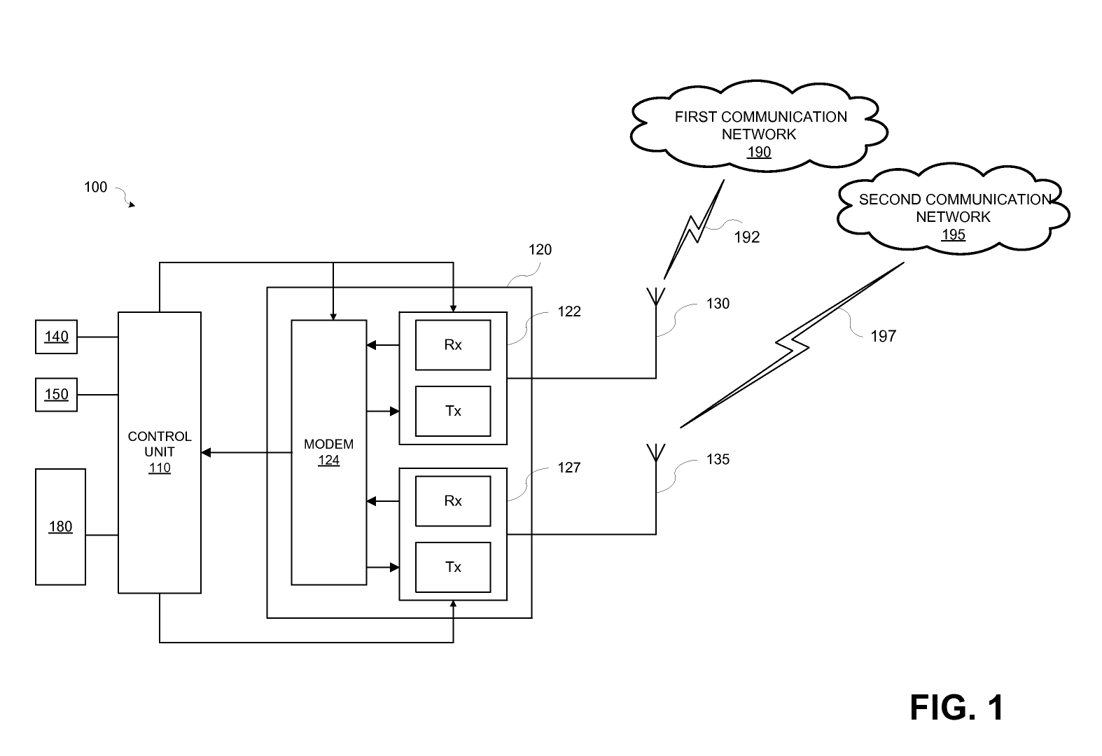

FIG. 1 is a block diagram illustrating a mobile communication device 100 according to various embodiments. As illustrated in FIG. 1, the mobile communication device 100 may include a control unit 110, a communication unit 120, a first antenna 130, a second antenna 135, a first subscriber identity module (SIM) 140, a second SIM 150, and a storage 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of the present inventive concept.

The first SIM 140 may associate the communication unit 120 with a first subscription (Sub1) 192 on a first communication network 190 and the second SIM 150 may associate the communication unit 120 with a second subscription (Sub2) 197 on a second communication network 195.

The first communication network 190 and the second communication network 195 may be operated by the same or different service providers, and/or may support the same or different communication technologies, for example, but not limited to, Wideband Code Division Multiple Access (WCDMA), Global System for Mobile communications (GSM), Long Term Evolution (LTE), Time Division-Synchronous Code Division Multiple Access (TD-SCDMA), etc.

The control unit 110 may be configured to control overall operation of the mobile communication device 100 including control of the communication unit 120, the user interface device 170, and the storage 180. The control unit 110 may be a programmable device, for example, but not limited to, a microprocessor or microcontroller.

The storage 180 may be configured to store application programs necessary for operation of the mobile communication device 100 that are executed by the control unit 110, as well as application data and user data.

The first communication unit 120 may include, for example, but not limited to, a first transceiver 122, a second transceiver 127, and a modem 124. The first transceiver 122 may receive signals from and supply signals to the modem 124. The transceiver 122 may process the signals received from the modem 124 for transmission as radio frequency (RF) signals via the first antenna 130 and may process RF signals received via the first antenna 130 and supply the processed signals to the modem 124

The second transceiver 127 may receive signals from and supply signals to the modem 124. The second transceiver 127 may process the signals received from the modem 124 for transmission as RF signals via the second antenna 135 and may process RF signals received via the second antenna 135 and supply the processed signals to the modem 124.

The communication unit 120 may be configured to communicate on one or more RATs. In active mode, the communication unit 120 may receive and transmit signals. In idle mode, the communication unit 120 may receive but not transmit signals.

One of ordinary skill in the art will appreciate that a separate transmitter and receiver may be used in place or a transceiver without departing from the scope of the present inventive concept.

In various embodiments, each subscription may be associated with one or more RATs, for example, GSM, WCDMA, TD-SCDMA, and LTE RATs. One of ordinary skill in the art will appreciate that these are only non-limiting examples and other combinations are possible.

Some embodiments may provide a two-stage dynamic estimation for TX power backoff: 1) a de-sense characterization backoff table may be generated during factory set-up/calibration; 2) an RX RAT frequency sweep backoff offset table may be generated during factory set-up/calibration. The de-sense characterization backoff table may be generated using a constant RX frequency and a constant TX frequency. The RX RAT frequency sweep backoff offset table may be generated using a constant TX center frequency and different RX frequencies (i.e., channels).

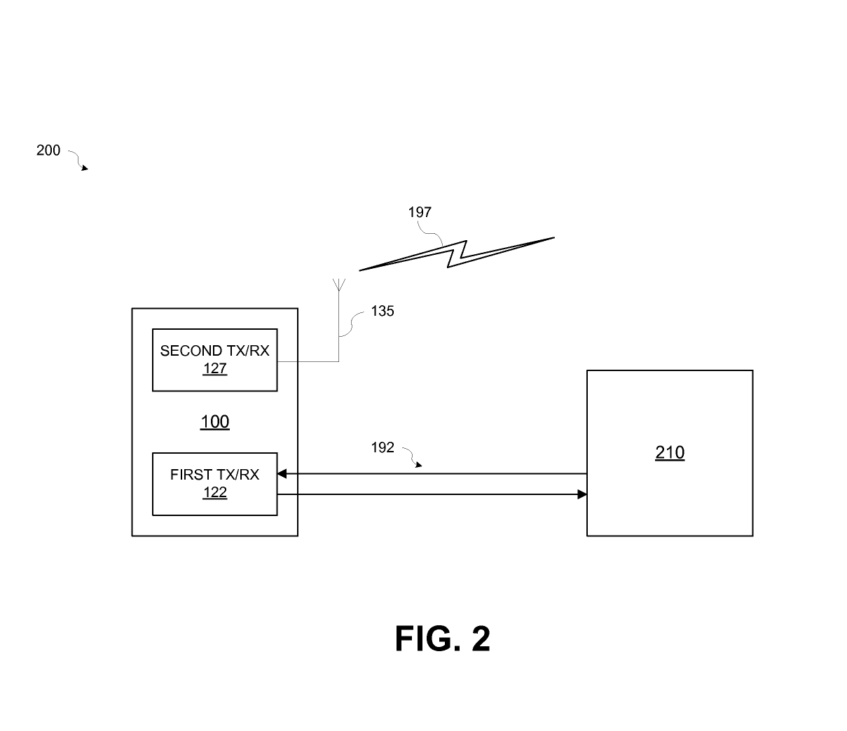

FIG. 2 is a diagram illustrating a setup 200 for generating the de-sense characterization backoff table and the RX RAT frequency sweep backoff offset table according to various embodiments. Referring to FIGS. 1-2, a transceiver (e.g., the first transceiver 122) for transmitting and receiving a victim RAT (e.g., the first RAT 192) in a mobile communication device 100 may communicate in a non-signaling mode with test equipment 210, for example a call box, to transmit and receive signals on the victim RAT. The mobile communication device 100 may measure the frame error rate (FER) of the victim RAT signal. Simultaneously, a transceiver (e.g., the second transceiver 127) for transmitting and receiving an aggressor RAT (e.g., the second RAT 197) in the mobile communication device 100 may continuously transmit at a predetermined frequency.

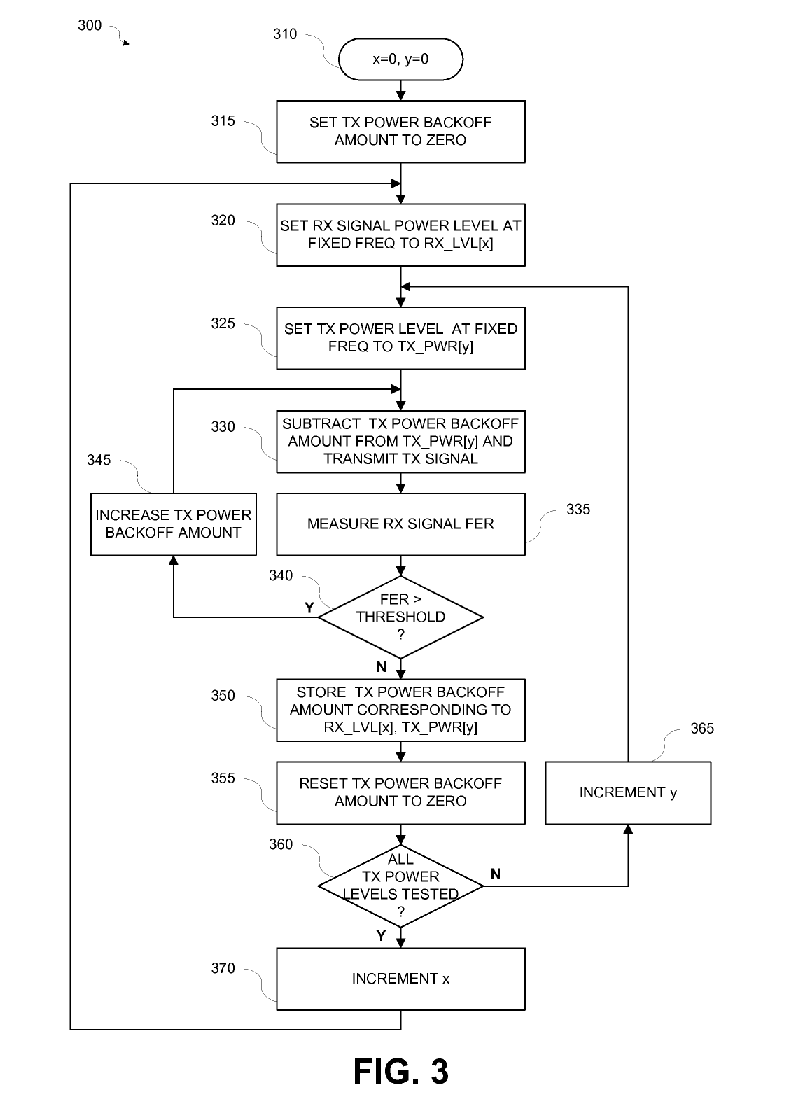

FIG. 3 is a flowchart illustrating a method 300 for generating a de-sense characterization backoff table according to various embodiments. Referring to FIGS. 1-3, counters x and y may be initialized to zero (310). A TX power backoff amount of the aggressor RAT (e.g., the second RAT 197) signal may be set to zero (315). The RX signal power level of the victim RAT (e.g., the first RAT 192) may be set to a power level RX_LVL[x] at a fixed frequency, for example, a center frequency of the RX band (320). The TX signal power level of the aggressor RAT signal may be set to a power level TX_LVL[y] at a fixed frequency, for example, a center frequency of the TX band (325). The center frequencies may be selected from overlapping frequency bands of the aggressor and victim RATs.

The TX power backoff amount may be subtracted from the TX signal power level TX_LVL[y] of the aggressor RAT signal and the aggressor RAT signal transmitted (330). The FER of the received victim RAT signal at the RX power level RX_LVL[x] may be measured (335). The FER may be compared to a predetermined threshold value, for example, but not limited to, 0.5% (340). If the FER of the victim RAT signal is greater than the predetermined threshold value (340-Y), the TX power backoff amount of the aggressor RAT signal may be increased by a predetermined amount, for example, 0.5 dbm (345) The increased TX power backoff amount may be subtracted from the TX signal power level TX_LVL[y] of the transmitted aggressor RAT signal (330). The FER of the received victim RAT signal at the RX power level RX_LVL[x] may again be measured (335).

The operations 340-Y, 345, 330, and 335 may repeat until the applied TX power backoff amount results in the measured FER of the received victim RAT signal at the RX power level RX_LVL[x] at the TX signal power level TX_LVL[y] of the transmitted aggressor RAT signal becoming equal to or less than the predetermined threshold value (340-N). The TX power backoff amount corresponding to the RX power level RX_LVL[x] and the TX signal power level TX_LVL[y] may be stored in the storage 180 (350). For example, the TX power backoff amount may be stored in a two-dimensional table correlating TX power backoff amount with RX power level RX_LVL[x] and TX signal power level TX_LVL[y] over a range of power levels x and y.

The TX power backoff amount may be reset to zero (355). If the FER at the set RX power level RX_LVL[x] for the victim RAT has not been measured and a TX power backoff amount has not been determined at all of the TX signal power levels TX_LVL[y] of the aggressor RAT (360-N), the counter y may be incremented (365). The TX signal power level TX_LVL[y] of the aggressor RAT may be set to the corresponding power level (325), and the process may be continued at operation 330.

If the FER at the set RX power level RX_LVL[x] for the victim RAT has been measured and a TX power backoff amount determined at all of the TX signal power levels TX_LVL[y] of the aggressor RAT (360-Y), the counter x may be incremented (370). The RX signal power level RX_LVL[x] of the victim RAT may be set to the corresponding power level (320). The process may be continued at operation 325 until a TX power backoff amount is determined for all of the RX signal power levels RX_LVL[x] of the victim RAT at all of the TX signal power levels TX_LVL[y] of the aggressor RAT. The TX power backoff amounts may be stored in a two-dimensional table correlating TX power backoff amount with RX power level RX_LVL[x] and TX signal power level TX_LVL[y] over a range of power levels x and y.

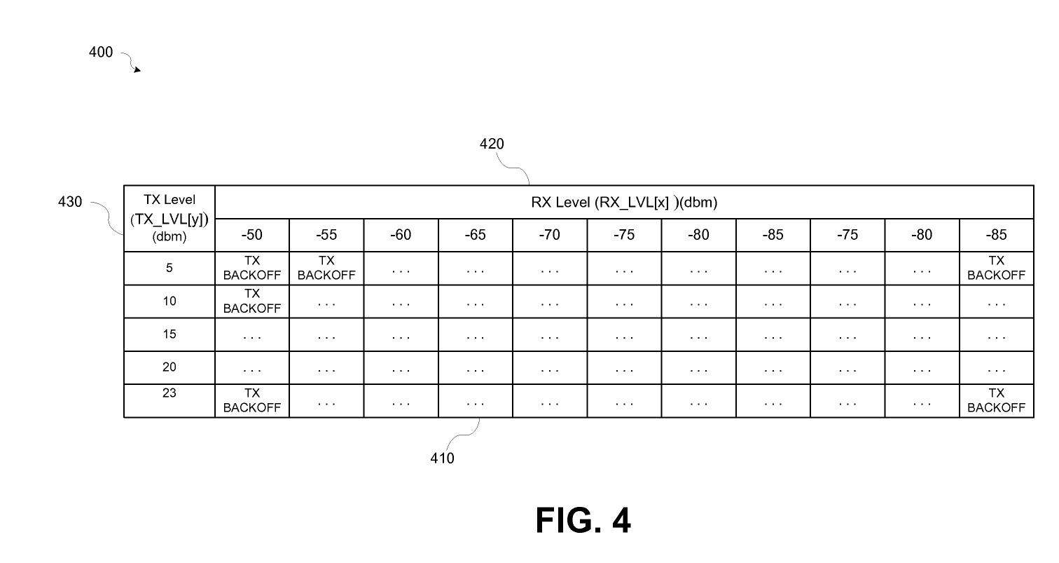

FIG. 4 is an example of a de-sense characterization backoff table 400 according to various embodiments. With reference to FIGS. 1-4, a TX power backoff amount 410 that results in the FER of the RX signal dropping below the predetermined threshold value is determined for each tested combination of RX power level RX_LVL[x] 420 and TX signal power level TX_LVL[y] 430. In operation, the control unit 110 of the mobile communication device 100 may interpolate a TX power backoff amount at a point between measured TX power backoff amounts 410 in the de-sense characterization backoff table 400. A plurality of de-sense characterization backoff tables 400 may be generated corresponding to different signal-to-noise ratios (SNR).

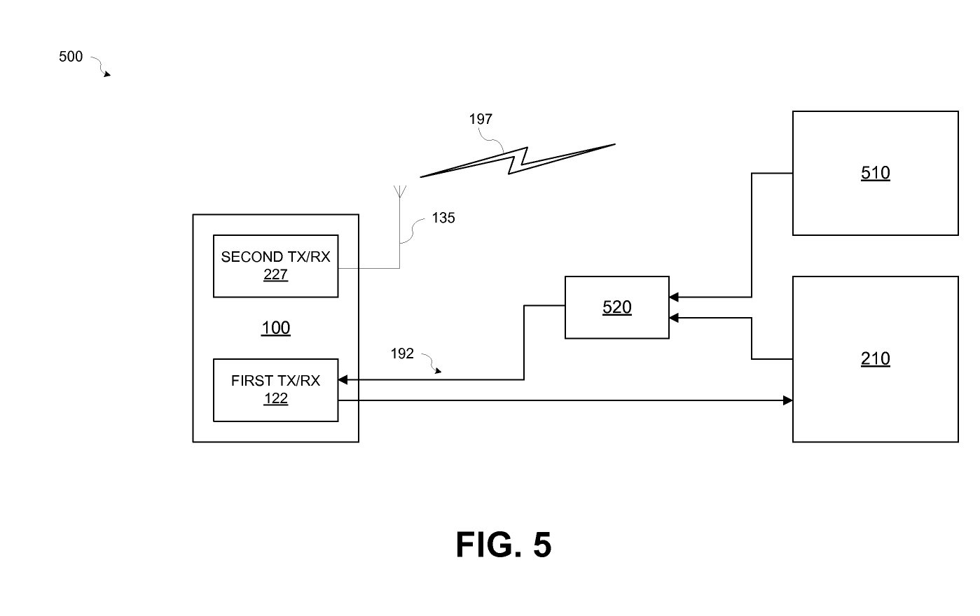

FIG. 5 is a diagram illustrating a setup 500 for generating de-sense characterization backoff tables corresponding to different SNRs according to various embodiments. Referring to FIGS. 1-5, a transceiver (e.g., the first transceiver 122) for transmitting and receiving a victim RAT (e.g., the first RAT 192) in a mobile communication device 100 may communicate in a non-signaling mode with test equipment 210, for example a call box, to transmit signals on the victim RAT. A noise generator 510 may generate noise signals that are combined via a combiner 520 with victim RAT signals generated by the test equipment 210. The combined signal may be transmitted to the victim RAT transceiver in the mobile communication device 100. Simultaneously, a transceiver (e.g., the second transceiver 127) for transmitting and receiving an aggressor RAT (e.g., the second RAT 197) in the mobile communication device may continuously transmit at a predetermined frequency.

The noise generator 510 may generate noise signals to produce a plurality of predetermined SNRs that are measured by the mobile communication device 100. The mobile communication device 100 may also opportunistically measure the FER. A de-sense characterization backoff table (e.g., de-sense characterization backoff table 400) may be generated for each of the predetermined SNRs.

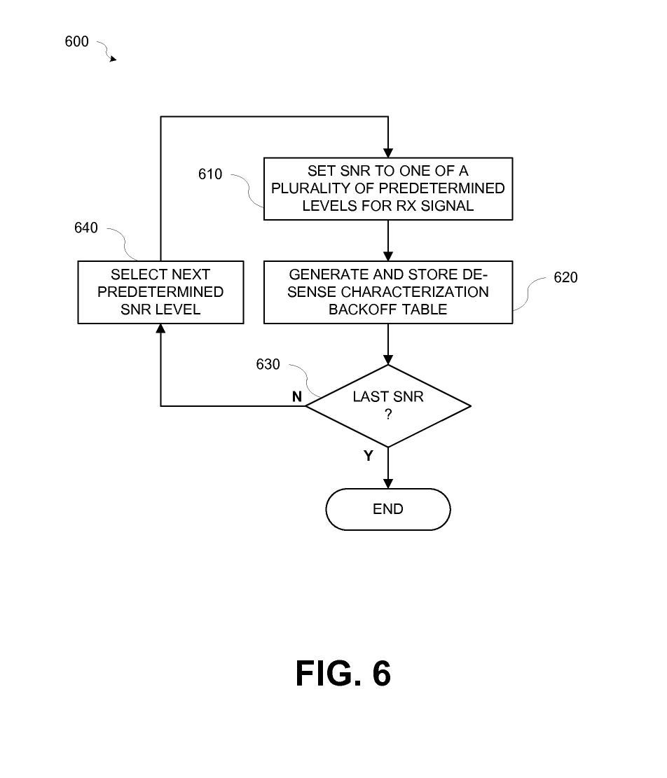

FIG. 6 is a flowchart illustrating a method 600 for generating a plurality of de-sense characterization backoff tables corresponding to different SNRs according to various embodiments. Referring to FIGS. 1-6, the SNR for the RX signal may be set, by the test equipment (e.g., the call box 210 and noise generator 510), to one of a plurality of predetermined SNRs (610). A de-sense characterization backoff table corresponding to the SNR may be generated, for example by the method 300, and stored in the storage 180 of the mobile communication device 100 (620). If a de-sense characterization backoff table has not been generated for each of the plurality of SNRs (630-N), the next predetermined SNR level may be selected (640) and the process may be repeated from operation 610. When a de-sense characterization backoff table has been generated for each of the plurality of SNRs (630-Y), the process may end.

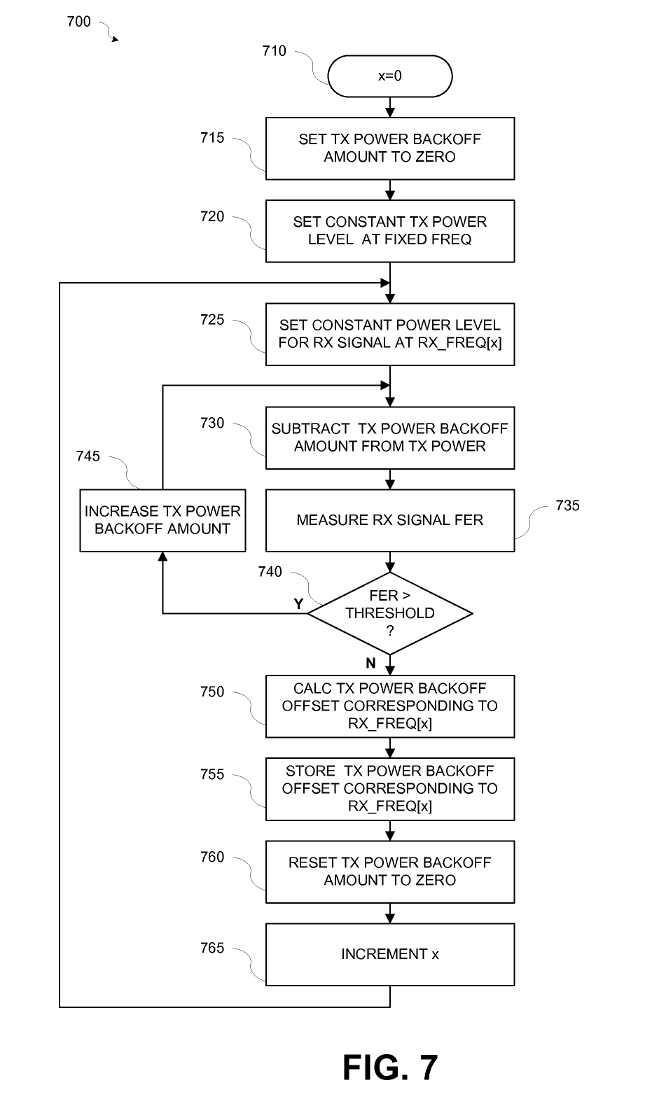

FIG. 7 is a flowchart illustrating a method 700 for generating an RX RAT frequency sweep backoff offset table according to various embodiments. Referring to FIGS. 1-7, the test equipment (e.g., the call box 210) may initialize a counter x to zero (710). A TX power backoff amount of the aggressor RAT (e.g., the second RAT 197) signal may be set to zero (715) by the control unit 110 in the mobile communication device 100. The TX signal power level of the aggressor RAT signal may be set to a constant power level at a fixed frequency, for example, a center frequency of the TX band (720). The RX signal power level of the victim RAT (e.g., the first RAT 192) may be set to a constant power level at an initial frequency (725). The frequencies may be selected from overlapping frequency bands of the aggressor and victim RATs.

The control unit 110 may subtract the TX power backoff amount from the TX signal power level of the transmitted aggressor RAT signal (730). The control unit 110 may cause the mobile communication device to measure the FER of the received victim RAT signal at the RX frequency RX_FREQ[x] (735). The FER may be compared to a threshold value, for example, but not limited to, 0.5% (740). If the FER of the victim RAT signal is greater than the threshold value (740-Y), the TX power backoff amount of the aggressor RAT signal may be increased by a predetermined amount, for example, 0.5 dbm (745). The increased TX power backoff amount may be subtracted from the TX signal power level of the transmitted aggressor RAT signal (730). The FER of the received victim RAT signal at the RX frequency RX_FREQ[x] may again be measured (735).

The operations 740-Y, 745, 730, and 735 may repeat until the applied TX power backoff amount results in the measured FER of the received victim RAT signal at the RX frequency RX_FREQ[x] at the TX signal power level of the transmitted aggressor RAT signal not greater than the predetermined threshold (740-N). The control unit 110 may calculate the TX power backoff offset from the corresponding TX power backoff amount determined during generation of the de-sense characterization backoff table (750). The calculated TX power backoff offset may be stored in the storage 180 (755). For example, the TX power backoff offset may be stored in a table correlating TX power backoff offset with RX frequency RX_FREQ[x] over a range of frequencies x. TX power backoff offset values between measured points maybe interpolated.

The TX power backoff amount may be reset to zero (760). The test equipment may increment the counter x (765). The RX signal power level of the victim RAT may be set to a constant power level at an RX frequency RX_FREQ[x] (725) by the control unit 110 in the mobile communication device 100. The process 700 may be repeated from operation 730 until a TX power backoff offset has been determined at all of the RX frequencies of interest.

Some embodiments may provide FER calculation for TX power backoff in runtime during overlap of TX RAT and RX RAT bands.

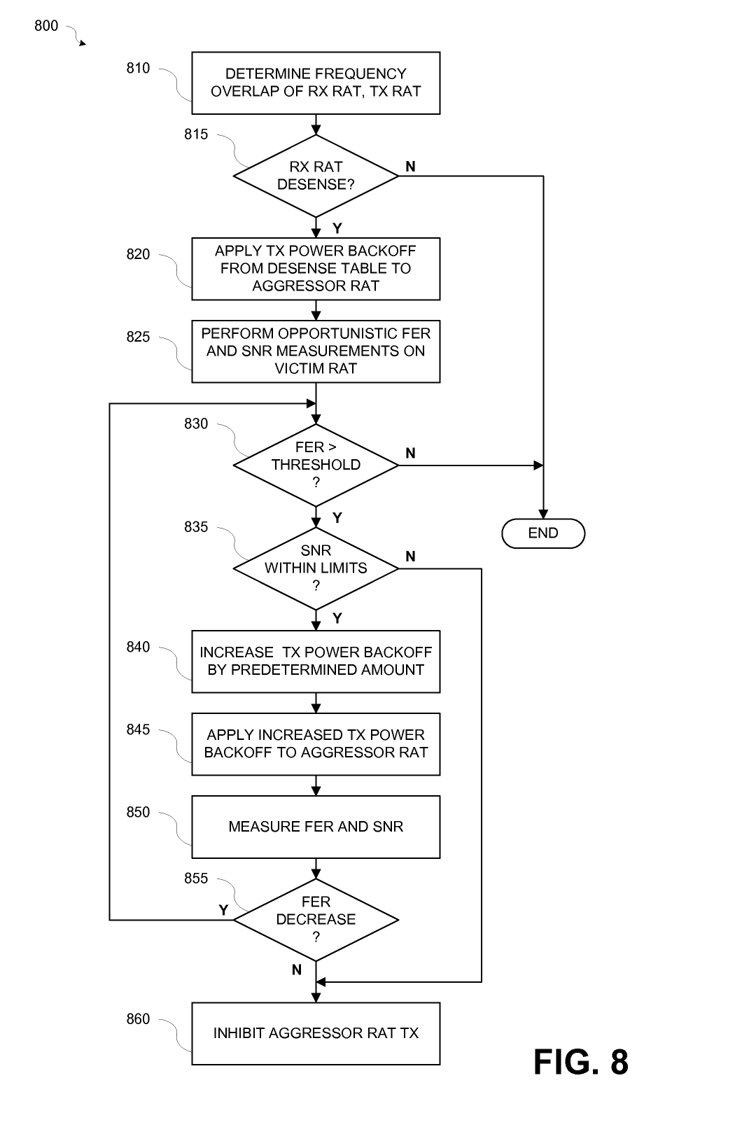

FIG. 8 is a flowchart illustrating a method 800 for calculating FER for TX power backoff in runtime according to various embodiments. Referring to FIGS. 1-8, the control unit 110 of the mobile communication device 100 may determine if a frequency overlap between an RX RAT and a TX RAT occurs (810). If no de-sense occurs on the RX RAT (815-N), the process ends. When de-sense occurs, the RX RAT is termed the victim RAT (e.g., the first RAT 192) and the TX RAT is termed the aggressor RAT (e.g., the second RAT 197).

If de-sense occurs (815-Y), TX power backoff may be applied to the aggressor RAT based on the TX signal power level of the aggressor RAT and the RX power level and SNR of the victim RAT signal according to the applicable de-sense characterization backoff table (820). The control unit 110 may cause the mobile communication device 100 to perform opportunistic FER and SNR measurements on the victim RAT signal (825). The control unit 110 may compare the FER to a predetermined threshold value, for example, but not limited to, 0.5% (830).

If the FER of the victim RAT signal is not greater than the predetermined threshold value (830-N), the process ends. If the FER of the victim RAT signal is greater than the predetermined threshold value (830-Y), the mobile communication device 100 may determine if the SNR of the victim RAT signal is within limits (835). The range for SNR may be different for different RATs. Acceptable SNR limits may vary, for example, between 0 and 20 db, based on the RAT. If the SNR of the victim RAT signal is not within limits (835-N), the mobile communication device 100 may inhibit transmission of the aggressor RAT signal (860).

If the SNR of the victim RAT signal is within limits (835-Y), the mobile communication device 100 may increase the TX power backoff of the aggressor RAT by a predetermined amount (840). The increased TX power backoff may be applied to the aggressor RAT (845). The control unit 110 may cause the mobile communication device 100 to measure the FER and SNR of the victim RAT signal (850). The control unit 110 may determine if the FER has decreased (855).

If the FER has not decreased (855-N), the mobile communication device 100 may inhibit transmission of the aggressor RAT signal (860). If the FER has decreased (855-Y), the mobile communication device 100 may determine if the FER of the victim RAT signal is still greater than the predetermined threshold (830). If the FER of the victim RAT signal is below the predetermined threshold (830-N), the process ends. If the FER of the victim RAT signal is still greater than the predetermined threshold (830-Y), the process may continue at operation 835.

Some embodiments may provide a de-sense learning table that is updated during mobile communication device 100 operation.

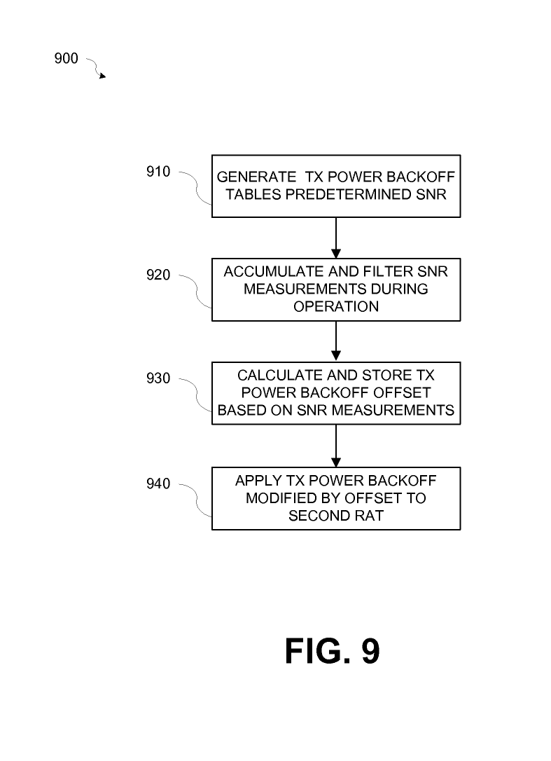

FIG. 9 is a flowchart illustrating a method 900 for generating an SNR TX power backoff offset table according to various embodiments. The control unit 110 may generate one or more de-sense characterization backoff tables corresponding to different predetermined SNRs, for example by the method 600 (910). During mobile communication device 100 operation, the control unit 110 may accumulate and filter SNR measurements over various SNR conditions (920). SNR TX power backoff offset values may be calculated based on the accumulated and filtered SNR measurements and may be stored in the storage 180 (930). For example, the SNR TX power backoff offset values based on different SNR conditions may be stored in SNR offset tables.

The SNR TX power backoff offset values may be used in conjunction with the one or more de-sense characterization backoff tables corresponding to different predetermined SNRs by applying the TX power backoff amounts based on different SNR conditions modified by the SNR TX power backoff offset values to the second RAT (940) to improve the accuracy of TX power backoff.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for determining transmission power backoff, the method comprising:
for each combination of a plurality of predetermined receive (RX) signal power levels and transmit (TX) signal power levels:
setting an RX signal power level for a first radio access technology (RAT) to one of the predetermined RX signal power levels;
setting a TX signal power level for a second RAT to one of the predetermined TX signal power levels;
subtracting a predetermined TX power backoff amount from the predetermined TX signal power level and transmitting the TX signal;
measuring a frame error rate (FER) of the RX signal; and
increasing the TX power backoff amount by a predetermined amount until the FER is not greater than a predetermined threshold value at the predetermined RX signal power level.

2. The method of claim 1, further comprising:
for each combination of the plurality of predetermined TX signal power levels and RX signal power levels, storing the corresponding TX power backoff amount resulting in the FER not greater than the predetermined threshold value.

3. The method of claim 1, wherein:
the TX signal is set to a fixed frequency in a TX frequency band, and
the RX signal is set to a fixed frequency in an RX frequency band.

4. The method of claim 3, wherein the fixed frequency of the TX signal is a center frequency of the TX frequency band.

5. The method of claim 3, wherein the fixed frequency of the RX signal is a center frequency of the RX frequency band.

6. The method of claim 3, wherein the TX frequency band and the RX frequency band overlap in frequency.

7. The method of claim 1, wherein the TX signal and the RX signal are different RAT signals.

8. A method for determining transmission power backoff offset, the method comprising:
for a plurality of predetermined receive (RX) signal frequencies:
setting a predetermined constant RX signal power level for a first radio access technology (RAT) at one of the predetermined frequencies;
setting a predetermined constant transmit (TX) signal power level for a second RAT at a fixed frequency;
subtracting a predetermined TX power backoff amount from the predetermined TX signal power level and transmitting the TX signal;
measuring a frame error rate (FER) of the RX signal; and
increasing the TX power backoff amount by a predetermined amount until the FER is not greater than a predetermined threshold value at the predetermined RX signal frequency.

9. The method of claim 8, further comprising:
for each of the plurality of predetermined RX signal frequencies:
calculating a TX power backoff offset between the predetermined constant TX signal power level and the TX power backoff amount resulting in the FER being not greater than the predetermined threshold value, and
storing the corresponding TX power backoff offset amount resulting in the FER not greater than the predetermined threshold value.

10. The method of claim 9, wherein the plurality of predetermined RX signal frequencies comprises an RX frequency band.

11. The method of claim 9, wherein the fixed frequency of the TX signal is a center frequency of the TX frequency band.

12. The method of claim 9, wherein the TX frequency band and the RX frequency band overlap in frequency.

13. The method of claim 8, wherein the TX signal and the RX signal are different RAT signals.

14. A method for determining transmission power backoff, the method comprising:
for each combination of a plurality of predetermined receive (RX) signal power levels, transmit (TX) signal power levels, and RX signal-to-noise ratios (SNRs):
setting an RX signal power level for a first radio access technology (RAT) to one of the predetermined power levels;
setting an RX signal SNR to one of the predetermined SNRs;
setting a TX signal power level for a second RAT to one of the predetermined power levels;
subtracting a predetermined TX power backoff amount from the predetermined TX signal power level and transmitting the TX signal;
measuring a frame error rate (FER) of the RX signal; and
increasing the TX power backoff amount by a predetermined amount until the FER is not greater than a predetermined threshold value at the predetermined RX signal power level and SNR.

15. The method of claim 14, further comprising:
for each combination of the plurality of predetermined TX signal power levels, RX signal power levels, and SNRs, storing the corresponding TX power backoff amount resulting in the FER not greater than the predetermined threshold value.

16. The method of claim 14, wherein:
the TX signal is set to a fixed frequency in a TX frequency band, and
the RX signal is set to a fixed frequency in an RX frequency band.

17. The method of claim 16, wherein the fixed frequency of the TX signal is a center frequency of the TX frequency band.

18. The method of claim 16, wherein the fixed frequency of the RX signal is a center frequency of the RX frequency band.

19. The method of claim 16, wherein the TX frequency band and the RX frequency band overlap in frequency.

20. The method of claim 14, wherein the TX signal and the RX signal are different RAT signals.

21. A method for backing off transmission power for a mobile communication device, the method comprising:
determining that a frequency band overlap exists between a receive (RX) frequency band for a first RAT and a transmit (TX) frequency band for a second RAT;
applying a TX power backoff to the second RAT, the TX power backoff corresponding to an RX signal power level for the first RAT and a TX power level for the second RAT;
performing frame error rate (FER) measurements and signal-to-noise (SNR) measurements on the RX signal on the first RAT;
increasing the TX power backoff to the second RAT by a predetermined amount and applying the increased TX power backoff to the second RAT; and
inhibiting second RAT transmissions if increasing the TX power backoff to the second RAT does not cause the FER of the RX signal on the first RAT to become equal to or less than a predetermined threshold.

22. The method of claim 21, wherein the applying a TX power backoff further comprises interpolating a TX power backoff amount when the RX signal power level for the first RAT and a TX power level for the second RAT are between stored measured values for RX signal power level in TX power level.

23. The method of claim 21, wherein the applying a TX power backoff further comprises applying the TX power backoff corresponding to an SNR for the RX signal level on the first RAT.

24. The method of claim 21, wherein the TX signal and the RX signal are different RAT signals.

25. The method of claim 21, further comprising:
during mobile communication device operation:
accumulating and filtering the SNR measurements for the first RAT signal over various SNR conditions;
calculating and storing TX power backoff amount offset values based on the SNR measurements over the various SNR conditions; and
applying a TX power backoff amount modified by a stored offset value corresponding to an SNR condition to the second RAT.
